(19) United States
(12) Patent Application Publication
(10) Pub. No.: US 2014/0044943 A1
(43) Pub. Date: Feb. 13, 2014

(54) MULTILAYER THERMOPLASTIC SEMI-FINISHED FIBER MATRIX PRODUCT

(71) Applicant: LANXESS DEUTSCHLAND GMBH, Leverkusen (DE)

(72) Inventors: Günter MARGRAF, Dormagen (DE); Detlev JOACHIMI, Krefeld (DE); Stefanie NICKEL, Willich (DE)

(21) Appl. No.: 14/055,999

(22) Filed: Oct. 17, 2013

Related U.S. Application Data
(63) Continuation of application No. 13/877,939.

(30) Foreign Application Priority Data
Oct. 8, 2010 (EP) 10187010.3

(51) Int. Cl. B32B 7/02; B32B 27/36; B32B 27/34; B32B 37/00; B32B 27/08

(52) U.S. Cl. CPC B32B 7/02; B32B 37/00; B32B 27/08; B32B 27/34; B32B 27/36
USPC 428/215; 156/324

(57) ABSTRACT

The invention relates to multilayer thermoplastic plate semi-finished products assembled in sandwich construction mode containing a core (A) of continuous fibre-reinforced thermoplastic composite materials or of long-fibre-reinforced thermoplastic composite materials the whole area whereof on the upper- and/or underside is bonded with at least one layer of a formable thermoplastic forming compound (B) which possesses a comparable or higher melting point than the matrix of the fibre-reinforced thermoplastic composite material in the core and at the forming temperature in the range of shear rates from 1/s-100/s displays an at least 10% higher melt viscosity measured according to ISO 11443 at residual moisture content <0.03% wherein the core (A) contains at least one reinforcing fibre and the use thereof in mechanically stressed structural components, preferably in motor vehicles, aircraft or wind power plants.

This application is a continuation of U.S. application Ser. No. 13/877,939, filed Apr. 5, 2013, now pending, which is, in turn, a 371 of PCT/EP2011/067593, which claims foreign priority benefits under under 35 U.S.C. §119 of European Patent Application No. 10187010.3, filed Oct. 8, 2010, the disclosures of which are incorporated herein by reference.

The invention relates to multilayer thermoplastic plate semi-finished products assembled in sandwich construction mode and the use thereof in mechanically stressed components, preferably in motor vehicles, aircraft or wind power plants.

Interlocking plastic-metal bonding technology, also called hybrid technology, is firmly established in automobile manufacture in the fabrication of heavy-duty, light structural components such as front ends, pedal support brackets or brake pedals and on account of the efficient reduced weight components makes a contribution to decreasing fuel consumption. The hybrid technology combines the high rigidity and strength and the ductility of the metal with the good dynamic properties and the high impact resistance of plastics, in practice preferably polyamide 6.

In the conventional plastic-metal hybrid technology, as a rule one or more overlapping thin-walled, preformed metal sheets or metal profiles are laid in the injection mould and then selectively reinforced with polyamide ribbing (In-Mold-Assembly or IMA process). Lasting frictional and interlocking anchoring between metal and plastic is ensured by perforations, ribbing and overforming At the same time, functions such as fixings and guide devices can be selectively introduced, which is described as function integration and opens up considerable potential for savings. Finishing of the moulded component is not necessary- in contrast to aluminium or magnesium diecast components (“Hybrid Front End as Structural Component”, Kunststoffe March 1999, Carl Hanser Verlag, pages 82-86).

A new approach for increasing the use and performance potential of hybrid technology and saving additional weight lies in the use of thermoplastic fibre matrix semi-finished products instead of heavy metal plates. The thermoplastic fibre matrix semi-finished products are selectively provided with polyamide ribbing and stiffeners in an injection mould. In this, the thermoplastic melt enters into intimate bonding with the semi-finished product, so that a material to material bond is produced (“Lighter than Steel”, Kunststoffe March 2010, Carl Hanser Verlag, pages 80-84).

Fibre matrix semi-finished products both based on thermosetting and also based on thermoplastic materials are available. In contrast to thermosetting semi-finished products, thermoplastic-based systems can be heated and thermally reformed several times. Moreover, thermoplastic fibre matrix semi-finished products can easily be welded.

The forming of the thermoplastic fibre matrix semi-finished product necessary for the structural component geometry can be effected in the standard hot forming process or in an injection mould during the closure of the mould.

The hot forming process is used for the production of three-dimensional moulded components from flat thermoplastic material semi-finished products (sheets and plates) with drawing in the thermoelastic state (Herrlich, Land, Kunz, Michaeli, “Plastics in Practice: Properties”, WEKA MEDIA Kissing, 2004, Part 10 Chapter 7.1 pages 1-5, Part 10 Chapter 7.4 pages 1-2; Michaeli, “Introduction to Plastics Processing.pdf”, Carl Hanser Verlag, Munich 2010, pages 185-190).

The procedure of thermal forming of thermoplastic fibre matrix semi-finished products is characterized by the following process steps (Reinforced Plastics Industrial Association, “Fibre Composite Plastics Handbook”, Vieweg+Teubner, Wiesbaden 2010, pages 477-482):
1. Manual or automated laying of the semi-finished product in a holding device (clamping frame)
2. Heating of the semi-finished product
3. Forming of the semi-finished product
4. Cooling of the formed semi-finished product
5. Demoulding of the formed semi-finished product

However, the forming of the thermoplastic fibre matrix semi-finished product can also for example be effected in a press, followed by transfer to an injection mould.

Before the further processing, the formed thermoplastic fibre matrix semi-finished products can be trimmed or otherwise further processed.

Thermoplastic fibre matrix semi-finished products are subdivided into the following groups (Schürmann, “Construction with fibre-plastic composites”, Springer-Verlag Berlin Heidelberg 2005, 2007, pages 156-157).:
Systems reinforced with long fibres:
   GMT: glass matt reinforced thermoplastics;
   LFT: long fibre reinforced thermoplastics
Systems reinforced with continuous fibres: thermoplastic prepregs

Depending on the production process and the different degree of impregnation and consolidation resulting therefrom, the following thermoplastic prepregs are distinguished (“Processing fibre-reinforced plastics”, Kunststoffe October 2003, Carl Hanser Verlag, pages 189-194):
Textile or hybrid yarn prepregs: production by textile processing methods from
   1. Polymer fibres and reinforcing fibres or
   2. Hybrid yarn
Powder prepregs: production via a powder scattering process
Solvent prepregs: production via a solvent bath
Film and melt prepregs: production via a pressing or lamination process with a melt or a sheet

In the context of the present invention, the terms thermoplastic prepreg and organic sheet are used synonymously.

Organic sheets are light and rigid plate semi-finished products made of a thermoplastic matrix wherein continuous fibres, partially or completely impregnated, are embedded. In these fibre composite materials, high-strength continuous fibres are combined specifically with plastics, preferably polyamide 6 and polyamide 66. While the fibres decisively determine the mechanical properties of the composite material such as strength and rigidity, the matrix material transmits the forces between the fibres, supports these against buckling and protects them from external attack. Continuous fibres of glass, carbon or aramid in the form of woven or nonwoven fabrics are preferably used. The fibres can for example be oriented in only one direction (unidirectional) or be at right angles to one another in two directions (orthotropic or balanced). Continuous fibres have the advantage that they can be introduced into the thermoplastic matrix very stretched with a high degree of orientation and thus in larger quantities. Moreover, they enable the force flow between force application points purely via the fibres, which increases the mechanical performance of the component.

For the fabrication of hybrid components according to the hybrid technology described above, instead of a metal plate, the organic plate is first formed or draped purely physically by hot forming in short cycle times. A preformed piece is produced, which is optionally heated until just below the melting point of the polymer matrix, then placed in an injection mould and reinforced at selected places with ribbings, preferably of polyamide 6.

Component corners in particular represent a challenge for this forming process of organic plates, since in these regions both a very high degree of forming and also a complex three-dimensional geometry are present (“More processing freedom for composites”, Kunststoffe January 2010, Carl Hanser Verlag, pages 26-28). An exact representation of the component corners and edges is often not possible, in addition through the application of pressure in the course of forming, damage to the continuous fibre reinforcement and thus weakening of the component created can result. Furthermore, during forming the continuous fibre fabric shifts. For example, the orthogonal arrangement of the fibres can be lost, which depending on the component sector leads to different orientations and fibre angles and hence to local differences in rigidity and strength.

From EP 0 470 605 A1, polyamide pipes are known which consist of at least three layer(s) of mutually compatible polyamide types, wherein at least one layer is reinforced with glass fibres. These polyamide pipes exhibit improved length stability after contact with fuel and are preferably produced by combination of melt streams in a coextrusion die.

A disadvantage with the products obtainable according to EP 0 470 605 A1 is that, in contrast to plate semi-finished products, after their production such pipes are generally no longer thermoformable (Herrlich, Land, Kunz, Michaeli, “Plastics in Practice: Properties”, WEKA MEDIA Kissing, 2004, Part 10 Chapter 7.1 pages 1-5, Part 10 Chapter 7.4 pages 1-2). Hollow parts according to EP 0 470 605 A1 therefore allow no recourse to thermoplastic plate semi-finished products, particularly as regards thermoforming

The objective of the present invention now consisted in providing fibre-reinforced thermoplastic plate semi-finished products which allow improved hot forming compared to the known semi-finished products.

Surprisingly, the problem was solved through multilayer thermoplastic plate semi-finished products built up in sandwich construction mode containing a core (A) of layer thickness 0.3 to 5 mm of continuous fibre-reinforced thermoplastic composite materials or of long-fibre-reinforced thermoplastic composite materials the whole area whereof on the upper- and/or underside is bonded with at least one layer of a formable thermoplastic forming compound (B) of layer thickness 0.1 to 3 mm which possesses a comparable or higher melting point than the matrix of the fibre-reinforced thermoplastic composite material in the core (A) and at the forming temperature in the range of shear rates from 1/s-100/s displays an at least 10% higher melt viscosity measured according to ISO 11443 at residual moisture content <0.03% wherein the core (A) contains 0.001 to 80 wt. % of at least one reinforcing fibre and this has a fibre diameter of 3 to 40 μm.

For clarity, it may be noted that all definitions and parameters enumerated below which are general, or are mentioned in preferred ranges, in any combinations are covered by the scope of the present invention.

The core (A) preferably has a thickness of 0.5-4 mm, particularly preferably of 1-2.5 mm

The thermoplastic material of the layer(s) (B) applied onto on the upper- and/or underside of core (A) respectively preferably has a thickness of 0.2-2 mm, particularly preferably of 0.6-1.5 mm.

The forming compound of the layer(s) (B) at the forming temperature in the range of shear rates from 1/s-100/s preferably has a melt viscosity measured according to ISO 11443 at a residual moisture content <0.03% at least 25% higher, particularly preferably at least 50% higher and quite particularly preferably at least 80% higher.

Preferably the core (A) and the layer(s) (B) are bonded together by gluing, welding, lamination or calendering.

According to the invention, the layer(s) (B) are preferably applied onto the core (A) by coating processes.

According to the invention, the core (A) consists of a reinforcing fibre arrangement in the form of continuous fibres or cut long fibres and the surrounding matrix of thermoplastic material.

As the thermoplastic matrix, the core (A) contains at least one thermoplastic polymer or copolymer. Polyamides, polyesters or polypropylene are preferably suitable. Polyamide 6 (PA 6) and polyamide 66 (PA 66) with relative solution viscosities in m-cresol of 2.0 to 4.0 and polybutylene terephthalate are particularly preferably suitable, particularly preferably polyamide 6 with a relative solution viscosity in m-cresol of 2.3-3.0 and polybutylene terephthalate. The measurement of the relative solution viscosity ηrel is effected on the basis of EN ISO 307. The ratio of the outflow time t of the polyamide dissolved in m-cresol to the outflow time t (0) of the solvent m-cresol at 25° C. yields the relative solution viscosity according to the formula ηrel=t/t(0). The polymers according to the invention can be produced by various processes, be synthesized from different building blocks and in the specific application case alone or in combination with processing aids, stabilizers, polymeric alloying partners (e.g. elastomers) or also reinforcing materials (such as for example mineral fillers or glass fibres) and optionally further additives, be finished into materials with specifically adjusted combinations of properties. Also suitable are blends with contents of other polymers, preferably of polyethylene, polypropylene or ABS, wherein optionally one or more compatibilizers can be used. The properties of the polyamides can be improved as needed by addition of elastomers, particularly as regards the impact resistance of the polymeric compounds.

For the production of polyamides, a large number of procedures have become known, wherein, depending on the desired end product, different monomeric building blocks or various chain regulators for establishment of a desired molecular weight or also monomers with reactive groups for intended subsequent aftertreatments are used.

As polyamides preferably to be used, polyamides are used the production whereof is effected via polycondensation in the melt. In the context of the present invention, the hydrolytic polymerization of lactams is also understood as polycondensation.

Preferably polyamides according to the invention are partially crystalline polyamides, which can be produced starting from diamines and dicarboxylic acids and/or lactams with at least 5 ring members or corresponding amino acids. Possible educts are preferably aliphatic and/or aromatic dicarboxylic acids, particularly preferably adipic acid, 2,2,4-trimethyladipic acid, 2,4,4-trimethyl-adipic acid, azelaic acid, sebacic acid, isophthalic acid, terephthalic acid, aliphatic and/or aromatic diamines, particularly preferably tetramethylenediamine, hexamethylenediamine, 1,9-nonane-diamine, 2,2,4- and 2,4,4-trimethylhexamethylenediamine, the isomeric diaminodicyclohexyl-methanes, diaminodicyclohexylpropanes, bisaminomethylcyclohexane, phenylenediamines, xylylenediamines, aminocarboxylic acids, in particular aminocaproic acid, or the corresponding lactams. Copolyamides of several of the said monomers are included.

Particularly preferably, polyamides from lactams are used, and quite particularly preferably caprolactams, and especially preferably ε-caprolactam, is used.

As thermoplastic matrix, the core (A) preferably contains polyamide produced by activated anionic polymerisation or copolyamide produced by activated anionic polymerization with polycaprolactam as the main component. The activated anionic polymerization of lactams to polyamides is effected on the industrial scale such that on the one hand a solution of catalyst in lactam is prepared, optionally with impact resistance modifier, and on the other a solution of activator in lactam, where usually both solutions are constituted such that simultaneous introduction in an equal ratio yields the desired overall formula. Further additives can optionally be added to the lactam melt. The polymerization is effected by mixing of the individual solutions to the overall formula at 80° C. to 200° C., preferably 100° C. to 140° C. Possible lactams are cyclic lactams with 6 to 12 C atoms, preferably laurolactam and particularly preferably ε-caprolactam. The catalyst in the sense of the invention is an alkali or alkaline earth metal lactamate, preferably as a solution in lactam, particularly preferably sodium caprolactamate in ε-caprolactam. As the activator in the sense of the invention, N-acyllactams or acid chlorides or, preferably, aliphatic isocyanates, particularly preferably oligomers of hexamethylene diisocyanate, can be used. As the activator, both the pure substance and also preferably a solution, preferably in N-methyl-pyrrolidone, can be used.

In a further preferred embodiment, the core (A) contains a thermoplastic matrix selected from the group of the polyesters, preferably polyalkylene terephthalates, particularly preferably the polybutylene terephthalates and polyethylene terephthalates, quite particularly preferably of polybutylene terephthalate.

Preferable polyalkylene terephthalates can be produced from terephthalic acid (or reactive derivatives thereof) and aliphatic or cycloaliphatic diols with 2 to 10 C atoms according to known methods (Plastics Handbook, Vol. VIII, pp. 695 ff, Karl Hanser Verlag, Munich 1973).

Preferable polyalkylene terephthalates contain at least 80 mol %, preferably 90 mol %, based on the dicarboxylic acid, of terephthalic acid residues and at least 80 mol %, preferably at least 90 mol %, based on the diol components, of ethylene glycol and/or 1,3-propanediol and/or 1,4-butanediol residues.

The preferable polyalkylene terephthalates can, as well as terephthalic acid residues, contain up to 20 mol % of residues of other aromatic dicarboxylic acids with 8 to 14 C atoms or residues of aliphatic dicarboxylic acids with 4 to 12 C atoms, such as residues of phthalic acid, isophthalic acid, naphthalene-2,6-dicarboxylic acid, 4,4′-diphenyldicarboxylic acid, succinic acid, adipic acid, sebacic acid, azelaic acid, cyclohexanediacetic acid and cyclohexanedicarboxylic acid.

The preferable polyalkylene terephthalate can, as well as ethylene glycol or 1,3-propanediol or 1,4-butanediol glycol residues, contain up to 20 mol % of other aliphatic diols with 3 to 12 C atoms or up to 20 mol % of cycloaliphatic diols with 6 to 21 C atoms, preferably residues of 1,3-propane-diol, 2-ethyl-1,3-propanediol, neopentyl glycol, 1,5-pentane diol, 1,6-hexanediol, 1,4-cyclohexane-dimethanol, 3-methyl-2,4-pentanediol, 2-methyl-2,4-pentanediol, 2,2,4-trimethyl-1,3-pentanediol 2,2,4-trimethyl-1,5-pentanediol, 2-ethyl-1,3-hexanediol, 2,2-diethyl-1,3-propanediol, 2,5-hexane-diol, 1,4-di-(β-hydroxyethoxy)benzene, 2,2-bis(4-hydroxycyclohexyl)propane, 2,4-dihydroxy-1,1,3,3-tetramethylcyclobutane, 2,2-bis(3-β-hydroxyethoxyphenyl)propane and 2,2-bis(4-hydroxy-propoxyphenyl)propane.

Particularly preferable are polyalkylene terephthalates which are produced only from terephthalic acid and reactive derivatives thereof, in particular dialkyl esters thereof, and ethylene glycol and/or 1,3-propanediol and/or 1,4-butanediol, particularly preferably polyethylene and polybutylene terephthalate and mixtures of these polyalkylene terephthalates.

Preferable polyalkylene terephthalates are also copolyesters which are produced from at least two of the aforesaid acid components and/or from at least two of the aforesaid alcohol components. Particularly preferable copolyesters are poly-(ethylene glycol/1,4-butanediol) terephthalates.

The polyalkylene terephthalates generally have an intrinsic viscosity of ca. 0.3 cm³/g to 1.5 cm³/g, preferably 0.4 cm³/g to 1.3 cm³/g, particularly preferably 0.5 cm³/g to 1.0 cm³/g each measured in phenol/o-dichlorobenzene (1:1 parts by weight) at 25° C.

The thermoplastic polyesters to be used according to the invention can also be used mixed with other polyesters and/or other polymers.

The core (A) preferably contains 30 to 75 wt. % of at least one reinforcing fibre, wherein the fibre diameters are preferably 6-25 μm, particularly preferably 8-18 μm. Preferably, the following reinforcing fibres are used alone or in mixtures as continuous (endless) fibre reinforcement or long fibre reinforcement:
glass fibres (Oberbach, Baur, Brinkmann, Schmachtenberg, “Saechtling Plastics Pocketbook”, Carl Hanser Verlag Munich Vienna 2004, pages 644-647),
metallized glass fibres
carbon fibres (Oberbach, Baur, Brinkmann, Schmachtenberg, “Saechtling Plastics Pocketbook”, Carl Hanser Verlag Munich Vienna 2004, page 648),
natural fibres (Oberbach, Baur, Brinkmann, Schmachtenberg, “Saechtling Plastics Pocketbook”, Carl Hanser Verlag Munich Vienna 2004, pages 650-652, 778-779),
plastic fibres, in particular high temperature plastic fibres (Oberbach, Baur, Brinkmann, Schmachtenberg, “Saechtling Plastics Pocketbook”, Carl Hanser Verlag Munich Vienna 2004, pages 648-650), preferably aramid fibres (Plastics Handbook, Vol. 3/4, pages 106-107, Carl Hanser Verlag Munich Vienna 1998),
steel fibres,
mineral fibres, in particular basalt fibres.

In a preferred embodiment, the reinforcing fibre is present as long fibre reinforcement, wherein the reinforcing fibres are longer than 100 mm and shorter than 2000 mm.

According to DIN 60000, a continuous fibre is a linear formation of practically unlimited length which can be processed as a textile. Chemical fibres are described as filaments, whereas the only continuous fibre occurring in nature is silk.

The use of continuous fibre structures such as woven or nonwoven fabrics etc. for the reinforcement of fibre composite components corresponds to the state of the art in applications in air and space travel and in racing. In contrast, the combination of continuous fibre structures with commodity fibre composite materials such as long fibre-reinforced thermoplastics (LFT) for local reinforcement of functionally integrated components, is a novel, innovative approach to light-weight construction which is cost-effective and suitable for mass production. Accordingly, for the implementation of such concepts in mass production, suitable technologies for the production and handling of the continuous fibre structures and low-cost raw materials enable component manufacture in a robust, single-stage manufacturing process.

Manufacturing technologies for the embedding of local continuous fibre reinforcement in long fibre-reinforced thermoplastics (LFT) have been the object of research for several years. The so-called tailored LFT technology in this operates in the hot extrusion process and uses woven or non-woven fabrics, unidirectional fibre profiles or individually created, geometrically matched, wound continuous fibre structures as semi-finished products

In a preferred embodiment of the present invention, the fibres are surface-modified, particularly preferably with a preferably silane-based coupling agent or coupling agent system. However, the pretreatment is not absolutely necessary.

Particularly with the use of glass fibres, in addition to silanes, polymer dispersions, emulsifiers, film forming agents (for example polyepoxide, polyether, polyolefin, polyvinyl acetate, polyacrylate or polyurethane resins or mixtures thereof), branching agents, further coupling agents, external lubricants, pH buffer substances and/or glass fibre processing aids (for example wetting agents and/or antistatic agents) are preferably also used. The further coupling agents, external lubricants and other additives, processes for the production of sizes, and processes for sizing and subsequent processing of the glass fibres are known and described for example in K. L. Löwenstein, “The Manufacturing Technology of Continuous Glass Fibres”, Elsevier Scientific Publishing Corp., Amsterdam. London, New York, 1983. The glass fibres can be sized by any methods, preferably by means of suitable devices, in particular with spray or roller applicators. Sizes can be applied onto the glass filaments drawn at high velocity from spinnerets immediately after their solidification, i.e. still before winding or cutting. However, it is also possible to size the fibres in a dipping bath following the spinning process.

The glass fibres particularly preferably to be used according to the invention preferably have either a circular cross-section surface and a filament diameter of 6 and 18 μm, preferably between 9 and 15 μm, or a flat shape and non-circular cross-section surface, the main cross-section axis whereof has a width in the range from 6-40 μm and the minor cross-section axis whereof has a width in the range from 3-20 μm The glass fibres are preferably selected from the group of the E-glass fibres, A-glass fibres, C-glass fibres, D-glass fibres, S-glass fibres and/or R-glass fibres. The fibres are in particular provided with a suitable sizing system and a coupling agent or coupling agent system, in particular quite particularly preferably silane-based.

Particularly preferable silane-based coupling agents for the pretreatment are silane compounds of the general formula (I)

(X—(CH₂)_{q})ₖ—Si—(O—CᵣH2ᵣ₊₁)₄₋ₖ (I)

wherein the substituents have the following meaning:

X stands for NH₂—, HO— or

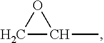

q stands for a whole number from 2 to 10, preferably 3 to 4,

r stands for a whole number from 1 to 5, preferably 1 to 2 and

k stands for a whole number from 1 to 3, preferably 1.

Quite particularly preferable coupling agents are monomeric organofunctional silanes, in particular 3-aminopropyltrimethoxysilane, aminobutyltrimethoxysilane, 3-aminopropyltriethoxysilane, aminobutyltriethoxysilane, 3-aminopropyltrismethoxyethoxysilane, 3-aminopropylmethyldiethoxysilane, N-methyl-2-aminoethyl-3-aminopropyltrimethoxysilane, N-methyl-2-aminoethyl-3-aminopropylmethyldimethoxysilane, N-methyl-3-aminopropyltrimethoxysilane, 3-glycidyloxypropyltrimethoxysilane, 3-methacryloxypropyltrimethoxysilane, 3-mercaptopropyltrimethoxysilane, vinyltriethoxysilane, vinyltrimethoxysilane, N-β-(aminoethyl)-γ-aminopropyltrimethoxysilane (Dynasilan Damo from Hüls AG), N-β(aminoethyl)-γ-aminopropyltriethoxysilane, N-β-(aminoethyl)-γ-aminopropylmethyldimethoxysilane and N-β-(aminoethyl)-N-β-(aminoethyl)-γ-aminopropyltrimethoxysilan.

The silane compounds are generally used in quantities from 0.05 to 5 wt. %, preferably 0.1 to 1.5 wt. % and in particular in quantities from 0.25 to 1 wt. % based on the filler for the surface coating.

The continuous fibre reinforcement preferably consists of reinforcing textiles in the form of woven or nonwoven fabrics, network, knitted fabrics and/or woven nettings (“Made to measure reinforcing textiles”, Kunststoffe June 2003, Carl Hanser Verlag, pages 46-49). It can also consist of nonwovens, fibre cables or rovings.

The production of the core (A) can be effected by impregnation in continuous or discontinuous processes of the reinforcing fibres present in the form of reinforcing textiles, nonwovens, fibre cables or rovings with thermoplastic forming compounds (Oberbach, Baur, Brinkmann, Schmachtenberg, “Saechtling Plastics Pocketbook”, Carl Hanser Verlag Munich & Vienna 2004, pages 207-209). The following impregnation procedures are preferable: by a powder scattering process, by an extrusion or lamination process with a melt or a film or by means of a solvent bath (“Processing fibre-reinforced plastics”, Kunststoffe October 2003, Carl Hanser Verlag, pages 189-194).

The production of the core (A) can also be effected by textile processing methods from fibres of the thermoplastic matrix and the reinforcing fibres or from hybrid yarns, followed by heat treatment with or without application of pressure (“Processing fibre-reinforced plastics”, Kunststoffe October 2003, Carl Hanser Verlag, pages 189-194).

The production of the core (A) can however also be effected by impregnation of the reinforcing fibre structure with a lactam melt containing activator and catalyst, followed by activated anionic polymerization, as for example described in EP 0 791 618 A1. The reinforcing fibre structure here can preferably be extensively covered from at least one side with a film or plate fabricated from a formable thermoplastic forming compound for the layer(s) (B). Particularly preferable is an embodiment wherein the core (A) is extensively covered on both sides with a film or plate fabricated from a formable thermoplastic forming compound for the layer(s) (B).

The thermoformable thermoplastic material of the layer(s) (B) bonded with the core (A) preferably has a comparable or higher melting point to or than the matrix of the fibre-reinforced thermoplastic composite material in the core (A). The thermoplastic material of the layer(s) (B) at the forming temperature in the range of shear rates from 1/s-100/s possesses an at least 10% higher, preferably at least 25% higher, particularly preferably at least 50% higher and quite particularly preferably at least 80% higher melt viscosity than the core (A), measured according to ISO 11443 at a residual moisture content <0.03% with a Malvern Instruments Ltd RH7 capillary rheometer and a capillary with an internal diameter of 1.0 mm, a length of 32 mm and an entrance angle of 180°.

As the thermoplastic material of the layer(s) (B), at least one thermoplastic polymer or copolymer is used. Polyamide or polyester are preferably suitable. Polyamide 6 (PA 6) and polyamide 66 (PA 66) with relative solution viscosities in m-cresol greater than 3.0, particularly preferably polyamide 6 with a relative solution viscosity in m-cresol greater than 3.5 but also polybutylene terephthalate, are particularly preferably suitable.

If the thermoplastic matrix of the core (A) consists predominantly of polypropylene, a thermoplastic material for the layer(s) (B) containing polyamide 6, polypropylene and compatibilizer (e.g. polypropylene modified with maleic anhydride) is particularly suitable.

In a preferred embodiment, the thermoplastic forming compound of the layer(s) (B) can contain 0.01 to 10 parts by weight, preferably 0.1 to 6 parts by weight, particularly preferably 0.5 to 5 parts by weight of di- or multifunctional additive with branching or chain-extending action containing at least two and at most 15 functional groups with branching or chain-extending action per molecule. Possible branching or chain-extending additives are low molecular weight or oligomeric compounds which have at least two and at most 15 functional groups with branching or chain-extending action per molecule, which can react with primary and/or secondary amino groups, and/or amide groups and/or carboxylic acid groups. Functional groups with chain-extending action are preferably isocyanates, blocked isocyanates, epoxides, maleic anhydride, oxazolines, oxazines or oxazolones.

Particularly preferable are diepoxides based on diglycidyl ethers (bisphenol and epichlorohydrin), based on amine-epoxide resin (aniline and epichlorohydrin), based on diglycidyl esters (cycloaliphatic dicarboxylic acids and epichlorohydrin) alone or in mixtures and 2,2-bis[p-hydroxyphenyl]propane diglycidyl ether, bis [p-(N-methyl-N-2,3-epoxypropylamino)phenyl]methane and epoxidized fatty acid esters of glycerine containing at least two and at most 15 epoxide groups per molecule.

Particularly preferable are glycidyl ethers, quite particularly preferably bisphenol A diglycidyl ethers and epoxidized fatty acid esters of glycerine, and also quite particularly preferably epoxidized soya oil (CAS 8013-07-8).

Epoxidized soya oil is known as a co-stabilizer and plasticizer for polyvinyl chloride (Plastics Additives Handbook, 5th Edition, Hanser-Verlag, Munich, 2001, p.460-462). It is in particular used in polyvinyl chloride seals of metal lids for airtight closure of jars and bottles.

The following are particularly preferably suitable for branching/chain extension:

1. Poly- or oligoglycidyl or poly-(β-methylglycidyl) ethers obtainable by reaction of a compound with at least two free alcoholic hydroxy groups and/or phenolic hydroxy groups and a suitably substituted epichlorohydrin under alkaline conditions, or in the presence of an acidic catalyst followed by alkali treatment.

Poly- or oligoglycidyl or poly-(β-methylglycidyl) ethers are preferably derived from acyclic alcohols such as ethylene glycol, diethylene glycol and higher poly-(oxyethylene) glycols, propane-1,2-diol, poly-(oxypropylene) glycols, propane-1,3-diol, butan-1,4-diol, poly-(oxytetramethylene) glycols, pentane-1,5-diol, hexane-1,6-diol, hexane-2,4,6-triol, glycerol, 1,1,1-trimethylpropane, bistrimethylolpropane, pentaerythritol, sorbitol and from polyepichlorohydrins.

They are however also preferably derived from cycloaliphatic alcohols such as 1,3- or 1,4-dihydroxycyclohexane, bis(4-hydroxycyclohexyl)methane, 2,2-bis(4-hydroxycyclohexyl)propane or 1,1-bis(hydroxymethyl)cyclohex-3-ene or they possess aromatic nuclei such as N,N-bis(2-hydroxyethyl)aniline or p,p′-bis(2-hydroxyethylamino)diphenylmethane.

The epoxide compounds can also preferably be derived from mononuclear phenols, in particular from resorcinol or hydroquinone; or they are based on polynuclear phenols in particular on bis(4-hydroxyphenyl)methane, 2,2-bis(4-hydroxyphenyl)propane, 2,2-bis(3,5-dibromo-4-hydroxyphenyl)propane, 4,4′-dihydroxydiphenylsulphone or on condensation products of phenols with formaldehyde under acidic conditions, such as phenol novolacs.

2. Poly- or oligo-(N-glycidyl) compounds also obtainable by dehydrochlorination of the reaction products of epichlorohydrin with amines which contain at least two amino hydrogen atoms. These amines are preferably aniline, toluidine, n-butylamine, bis(4-aminophenyl)methane, m-xylylenediamine or bis(4-methylaminophenyl)methane, but also N,N,O-triglycidyl-m-aminophenol or N,N,O-triglycidyl-p-aminophenol.

However, the poly-(N-glycidyl) compounds also preferably include N,N′-diglycidyl derivatives of cycloalkylene ureas particularly preferably ethylene urea or 1,3-propylene urea, and N,N′-diglycidyl derivatives of hydantoins, in particular 5,5-dimethylhydantoin.

3. Poly- or oligo-(S-glycidyl) compounds, in particular di-S-glycidyl derivatives which are derived from dithiols, preferably ethane-1,2-dithiol or bis(4-mercaptomethylphenyl) ether.

4. Epoxidized fatty acid esters of glycerine, in particular epoxidized plant oils. They are obtained by epoxidation of the reactive olefin groups of triglycerides of unsaturated fatty acids. The production of epoxidized fatty acid esters of glycerine can be effected starting from unsaturated fatty acid esters of glycerine, preferably from plant oils, and organic peroxycarboxylic acids (Prileschajew reaction). Processes for the production of epoxidized plant oils are for example described in Smith, March, March's Advanced Organic Chemistry (5^{th} Edition, Wiley-Interscience, New York, 2001). Preferable epoxidized fatty acid esters of glycerine are plant oils. Particularly preferable epoxidized fatty acid esters of glycerine according to the invention are epoxidized soya oil (CAS 8013-07-8).

The thermoplastic forming compound of the layer(s) (B) can moreover contain processing aids, stabilizers, polymeric alloying partners (e.g. elastomers), reinforcing materials (e.g. glass fibres) and optionally further additives.

The production of the multilayer thermoplastic plate semi-finished product can be effected by joining together the core (A), consisting of continuous fibre-reinforced thermoplastic composite materials or of long-fibre-reinforced thermoplastic composite materials, and the thermoformable thermoplastic material of the layer(s) (B), in one or more steps.

For this, powder, granules, melt, nonwoven, film or plate goods of the thermoformable thermoplastic material of the layer(s) (B) is applied over the whole area onto the core (A) in continuous or discontinuous processes optionally under the action of heat and/or pressure or vacuum.

Plate goods of the thermoplastic material of the layer(s) (B) can for example be produced by injection forming, extrusion or pressing processes. Film goods can be produced by the current processes for film production.

The thermoformable thermoplastic material of the layer(s) (B) can be applied onto the core (A) over the whole area by lamination or (repeated) coating (Oberbach, Baur, Brinkmann, Schmachtenberg, “Saechtling Plastics Pocketbook”, Carl Hanser Verlag Munich & Vienna 2004, pages 264-266):
Application with rollers, in particular melt-rolling processes and hot melt processes,
Lamination by means of suitable laminating agents (paint, glue, wax), so-called wet lamination or dry lamination with heat and optionally pressure, so-called thermo-lamination
Spreading of the material of the layer(s) (B), melted or dissolved in a solvent, with thickness-defining spreading knife (doctor blade)
Combination of material of the layer(s) (B) in the form of films, plates or nonwovens with core (A) by means of a calender

The coating can however also be effected in the dipping process by dipping the core (A) into a melt of the thermoplastic material of the layer(s) (B) (Oberbach, Baur, Brinkmann, Schmachtenberg, “Saechtling Plastics Pocketbook”, Carl Hanser Verlag Munich & Vienna 2004, pages 272-273).

The thermoplastic material of the layer(s) (B) can also be applied in the form of sheets or films by gluing onto the core (A) over the whole area. Preferably, polyamides can be glued with polymeric melt adhesives, acrylate adhesives or solutions of polyamide in formic acid.

The core (A) can also be bonded with the thermoplastic material of the layer(s) (B) over the whole area by welding. Preferable welding processes are ultrasonic welding, hot element welding, vibration welding, rotary friction welding or high frequency welding (Plastics Handbook, Vol. 3/4, pages 106-107, Carl Hanser Verlag Munich & Vienna 1998).

A further preferred welding process is laser transmission welding (Oberbach, Baur, Brinkmann, Schmachtenberg, “Saechtling Plastics Pocketbook”, Carl Hanser Verlag Munich & Vienna 2004, page 342). In a preferred embodiment, the thermoplastic material of the layer(s) (B) displays higher transmission for electromagnetic radiation of wavelengths 500-1500 nm than the material to be used for the core (A).

Before coating, the core (A) of continuous fibre-reinforced thermoplastic composite materials or of long-fibre-reinforced thermoplastic composite materials can preferably be surface pretreated by means of the following processes (Ehrenstein, “Handbuch Kunststoff-Verbindungstechnik”, Carl Hanser Verlag Munich 2004, pages 494-504):
Mechanical treatment, preferably by brushing or grinding,
Cleaning with liquids, preferably with aqueous solutions or organics solvents for removal of surface deposits
Flame treatment, preferably with propane gas, natural gas, town gas or butane
Corona treatment (potential-loaded atmospheric pressure plasma)
Potential-free atmospheric pressure plasma treatment
Low pressure plasma treatment (air and O₂ atmosphere)
UV light treatment
Chemical pretreatment, e.g. by wet chemistry by gas phase pretreatment
Primers and coupling agents

The multilayer thermoplastic plate semi-finished products according to the invention preferably have the layer arrangement (B)-(A)-(B′). The semi-finished products (B)-(A)-(B′) can be produced such that the edges are stopped or covered or sealed with material of the layer(s) (B) or other thermoplastic materials with a similar melting point to that of the layer(s) (B). Preferable according to the invention are plate semi-finished products wherein the core (A) consists of PA6 and the layer(s) (B) of PA66 or wherein the core (A) consists of PA6 and the layer(s) (B) of PA6 or wherein the core (A) consists of PA66 and the layer(s) (B) of PA66 or wherein the core (A) consists of PBT and the layer(s) (B) of PET or wherein the core (A) consists of PP and the layer(s) (B) of PA6 (PA=polyamide; PP=polypropylene; PET=polyethylene terephthalate; PBT=polybutylene terephthalate). In the sense of the present invention, (B′) means the same thermoplastic material or a thermoplastic material, which differs in its composition from (B), whether this is due to the thermoplastic itself or due to the addition of additives if the same thermoplastic as in (B) is used.

In a preferred embodiment, the plate semi-finished product at the start of forming has a temperature which lies 10-90° C. above the melting point of the thermoplastic component of material (A), preferably lies 30-80° C. above the melting point of the thermoplastic component of material (A), particularly preferably lies 35-65° C. above the melting point of the thermoplastic component of material (A), and quite particularly preferably lies 55-64° C. above the melting point of the thermoplastic component of material (A). The determination of the melting point is effected by differential scanning calorimetry DSC (maximum of the peak position in the first heating, heating rate 20° C./min).

However, the present invention also relates to a process for the production of the plate semi-finished products characterized in that core (A), consisting of continuous fibre-reinforced thermoplastic composite materials or of long-fibre-reinforced thermoplastic composite materials, is joined together with the thermoformable thermoplastic material of the layer(s) (B), in one or more steps by roller application, lamination, spreading or by means of a calender or by dipping of the core (A) into a melt of the thermoplastic material of the layer(s) (B) and joining together means gluing, welding, lamination or calendaring.

Preferably, this process is performed in that the plate semi-finished product at the start of forming has a temperature which lies 10-90° C. above the melting point of the thermoplastic component of material (A), preferably lies 30-80° C. above the melting point of the thermoplastic component of material (A), particularly preferably lies 35-70° C. above the melting point of the thermoplastic component of material (A), and quite particularly preferably lies 55-64° C. above the melting point of the thermoplastic component of material (A).

However, the present invention also relates to the use of the plate semi-finished products according to the invention in mechanically stressed structural components, preferably as components to be mechanically stressed in motor vehicles, aircraft or wind power plants.

### PRACTICAL EXAMPLES

As examples according to the invention, the three-layer thermoplastic fibre matrix semi-finished products with a structure (B)-(A)-(B′) are mentioned. The semi-finished product was produced by gluing of the layer (A) with extruded films of thickness 0.25 mm (Examples 1, 8, 12, Comparison 1) or with extruded plates of thickness 0.75 mm (Examples 2-7, 9-11, 13). Next, the plates were mounted in a clamping frame, heated by means of an infrared lamp, and formed into a three-dimensional component. After cooling had taken place, the formed semi-finished product is demoulded. Next, the formed semi-finished products are incinerated for 8 hours at 450° C. in a muffle furnace. The remaining structure of the reinforcing fibre of core (A) is visually examined.

Examples 1-12 according to the invention can easily be deformed. In the course of the forming, only a small measure of damage to the reinforcing fibre of core (A) occurs. In contrast, Comparative Example 1 is difficult to deform, and marked damage of the reinforcing fibre of core (A) occurs.

| | | | Temperature directly |
|---|---|---|---|
| | Layer (A) | Layer (B) = (B′) | before forming [° C.] |
| Example 1 | PA6 with 47 vol. % continuous glass | PA66 unreinforced | 290 |
| | reinforcement (TEPEX ® dynalite 102- | (Durethan ® A30)⁵ | |
| | RG600(4)/47%, thickness: 2 mm, | | |
| | weight per unit area 600 grams/m², | | |
| | twill, warp:weft 50:50)¹ | | |
| Example 2 | PA6 with 47 vol. % continuous glass | PA66 GF15 | 290 |
| | reinforcement (TEPEX ® dynalite 102- | (Durethan ® DP 2- | |
| | RG600(4)/47%, thickness: 2 mm, | 2240/15 H2.0)⁶ | |
| | weight per unit area 600 grams/m², | | |
| | twill, warp:weft 50:50)¹ | | |
| Example 3 | PA6 with 47 vol. % continuous glass | PA66 GF25 | 290 |
| | reinforcement (TEPEX ® dynalite 102- | (Durethan ® AKV325 | |
| | RG600(4)/47%, thickness: 2 mm, | H2.0)⁷ | |
| | weight per unit area 600 grams/m², | | |
| | twill, warp:weft 50:50)¹ | | |
| Example 4 | Cast polyamide PA6-G with 65 wt. % | PA66 GF 25 | 290 |
| | continuous glass reinforcement | (Durethan ® AKV325 | |
| | | H2.0)⁷ | |
| Example 5 | PA6 with 47 vol. % continuous glass | PA66 GF25 | 290 |
| | reinforcement (TEPEX ® dynalite 102- | (Durethan ® AKV325 | |
| | RG600(4)/47%, thickness: 2 mm, | H2.0)⁷ | |
| | weight per unit area 600 grams/m², | | |
| | twill, warp:weft 50:50)¹ | | |
| Example 6 | PA6 with 47 vol. % continuous glass | PA6 GF15 (Durethan ® | 280 |
| | reinforcement (TEPEX ® dynalite 102- | BKV315Z H2.0)⁸ | |
| | RG600(4)/47%, thickness: 2 mm, | | |
| | weight per unit area 600 grams/m², | | |
| | twill, warp:weft 50:50)¹ | | |
| Example 7 | PA6 with 47 vol. % continuous glass | PA6 GF25 (Durethan ® | 280 |
| | reinforcement (TEPEX ® dynalite 102- | BKV325Z H2.0)⁹ | |
| | RG600(4)/47%, thickness: 2 mm, | | |
| | weight per unit area 600 grams/m², | | |
| | twill, warp:weft 50:50)¹ | | |
| Example 8 | PBT with 65 wt. % continuous glass | PET unreinforced | 280 |
| | reinforcement | | |
| Example 9 | PP with 45 vol. % continuous glass | (PA6 + PP) GF30¹² | 225 |
| | reinforcement (TEPEX ® dynalite 104- | | |
| | FG290(4)/45%, thickness: 1 mm, | | |
| | weight per unit area 290 gr/m², twill, | | |
| | warp:weft 50:50)² | | |
| Example 10 | PA6 with 45 vol. % hybrid woven of | PA66 GF15 | 290 |
| | carbon and aramid fibres (TEPEX ® | (Durethan ® DP 2- | |
| | dynalite 502-CA210(4)/45%, thickness: | 2240/15 H2.0)⁶ | |
| | 0.8 mm, weight per unit area 210 gr/m², | | |
| | twill, warp:weft 50:50)³ | | |
| Example 11 | PA66 with 45 vol. % carbon fibre | PA66 GF25 | 290 |
| | reinforcement (TEPEX ® dynalite 201- | (Durethan ® AKV325 | |
| | C200(2)/45%, thickness: 1 mm, weight | H2.0)⁷ | |
| | per unit area 200 gr/m², twill, warp:weft | | |
| | 50:50)⁴ | | |
| Example 12 | PA6 with 47 vol. % continuous glass | PA6 unreinforced | 280 |
| | reinforcement (TEPEX ® dynalite 102- | (Durethan ® | |
| | RG600(2)/47%, thickness: 1 mm, | DPBC600HTS)¹⁰ | |
| | weight per unit area 600 grams/m², | | |
| | twill, warp:weft 50:50)¹ | | |
| Example 13 | Cast polyamide PA6-G with 65 wt. % | PA66 GF15 | 290 |
| | aramid fibre continuous reinforcement | (Durethan ® DP 2- | |
| | | 2240/15 H2.0)⁶ | |
| Comparison 1 | PA6 with 47 vol. % continuous glass | PA6 unreinforced | 270 |
| | reinforcement (TEPEX ® dynalite 102- | (Durethan ® B30S)¹¹ | |
| | RG600(2)/47%, thickness: 1 mm, | | |
| | weight per unit area 600 grams/m², | | |
| | twill, warp:weft 50:50)¹ | | |

¹⁻⁴Commercial product of Bond-Laminates GmbH
⁵⁻¹¹Commercial products of Lanxess Germany GmbH
¹²Blend of PA6 (Durethan ® B29 from Lanxess Germany GmbH) with 15 wt. % homo-polypropylene and 5 wt. % Exxelor VA1801, reinforced with 30 wt. % glass fibres (CS7928 from Lanxess N.V.)

1. Plate semi-finished product containing a core (A) of layer thickness 0.3 to 5 mm of continuous fibre-reinforced thermoplastic composite materials or of long-fibre-reinforced thermoplastic composite materials the whole area whereof on the upper- and/or underside is bonded with at least one layer of a formable thermoplastic forming compound (B) of layer thickness 0.1 to 3 mm which possesses a comparable or higher melting point than the matrix of the fibre-reinforced thermoplastic composite material in the core (A) and at the forming temperature in the range of shear rates from 1/s-100/s displays an at least 10% higher melt viscosity measured according to ISO 11443 at residual moisture content <0.03% wherein the core (A) contains 0.001 to 80 wt. % of at least one reinforcing fibre and this has a fibre diameter of 3 to 40 μm, wherein core (A) is built upon with the layer(s) (B) multilayered in sandwich construction mode.

2. Plate semi-finished products according to claim 1, wherein the forming temperature at the start of the forming lies at least 3° C. above the melting point of the material for the core (A) but at most 10° C. above the melting point of the material of the layer(s) (B).

3. Plate semi-finished product according to claim 1, wherein long fibre reinforcement present as reinforcing fibre has reinforcing fibres longer than 100 mm and shorter than 2000 mm

4. Plate semi-finished products according to claim 1, wherein the core (A) and the layer(s) (B) are bonded by gluing, welding, lamination or calendering.

5. Plate semi-finished products according to claim 1, wherein the layer(s) (B) are applied onto the core (A) by coating processes.

6. Plate semi-finished products according to claim 1, wherein the core (A) consists of PA6 and the layer(s) (B) of PA66 or that the core (A) consists of PA6 and the layer(s) (B) of PA6 or that the core (A) consists of PA66 and the layer(s) (B) of PA66 or that the core (A) consists of PBT and the layer(s) (B) of PET or that the core (A) consists of PP and the layer(s) (B) of PA6.

7. A mechanically stressed structural component comprising the plate semi-finished products according to claim 1.

8. Structural component according to claim 7, which is a mechanically stressed structural component in a motor vehicle, aircraft or wind power plant.

9. Method for the production of the plate semi-finished products according to claim 1, comprising joining core (A), consisting of continuous fibre-reinforced thermoplastic composite materials or of long-fibre-reinforced thermoplastic composite materials, together with the thermoformable thermoplastic material of the layer(s) (B), in one or more steps by application of rollers, lamination, spreading or by means of calenders or by dipping of the core (A) into a melt of the thermoplastic material of the layer(s) B and joining together means gluing, welding, lamination or calendering.

10. Method according to claim 9, wherein the plate semi-finished product at the start of forming displays a temperature which lies 10-90° C. above the melting point of the thermoplastic component of material (A).
